(19) United States
(12) Patent Application Publication
(10) Pub. No.: US 2004/0174250 A1
(43) Pub. Date: Sep. 9, 2004

(54) Bomb and firearm defense system (BFDS)

(76) Inventors: Patricia Nichole Griffin, Park Forest, IL (US); Sinatra Frank Griffin, Park Forest, IL (US)

Correspondence Address: PATRICIA GRIFFIN, 9 MANTUA COURT, PARK FOREST, IL, 60466, US

(21) Appl. No.: 10/771,568

(22) Filed: Feb. 4, 2004

Related U.S. Application Data
(60) Provisional application No. 60/445,556, filed on Feb. 6, 2003.

(51) Int. Cl. G08B 1/00

(52) U.S. Cl. 340/286.01

(57) ABSTRACT

According to the National Commission on Terrorism (U.S.), terrorists are becoming more dangerous, crossing borders and making use of available technologies to communicate quickly and securely. Today, terrorists are aimed at attacks that cause as many fatalities as possible and will go into any territory they can.

The Bomb and Firearm Defense System supports all governmental entities involved with countering domestic and foreign terrorism by identifying the existence of a threat and minimizing its devastation. This system is integrated within infrastructures targeting areas where civilians live, work and visit.

BFDS utilizes robotic scanners and enhanced radiographic technology for thorough search and detection. Other methodologies within BFDS include the improvement of transport systems, specifically public transportation vehicles, utilizing material discrimination technology and real time surveillance, providing overall protection of passengers and transit employees.

### CROSS-REFERENCE TO RELATED APPLICATIONS

Bomb and Firearm Defense System (BFDS) was filed as a provisional patent application on Feb. 6, 2003; application No. 60/445,556; confirmation number 9319.

### STATEMENTS REGARDING FEDERALLY SPONSORED RESEARCH OR DEVELOPMENT

Non Applicable

### REFERENCE TO SEQUENCE LISTING, A TABLE, OR A COMPUTER PROGRAM LISTING COMPACT DISK APPENDIX

Non Applicable

### BACKGROUND OF THE INVENTION

Th Bomb and Firearm Defense System pertain to transportation security, public safety and defense. As the threat of bombs and firearms increase, protection methods are needed to deter perpetrators and decrease injury among civilians and governing officials. BFDS addresses this issue.

### BRIEF SUMMARY OF THE INVENTION

The Bomb and Firearm Defense System uphold the same objective as many liberated countries: creating a lifestyle of freedom through heightened security measures. It creates flexibility and enables state and local governments to counter terrorism quickly and efficiently.

BFDS consists of two subcategories: robotic scanners (RS) and transport systems (TS).

Within the RS subcategory, the Bomb and Firearm System offers (3) three detection systems—two are a combination of Computer Axial Tomography along with X-Ray Fluorescence Spectrometry. The third installment integrates Chromatography and Mass Spectrometry with high voltage, low amperage electrical charge and/or directed-energy beam weaponry.

Improving prior arts of Computer Axial Tomography, Spectrometry, and dispersing electrical charge/directed-energy beams are achieved through the integration of these arts into one device as described in the “Detailed Description of the Invention”. Further enhancements include joining these arts with robotic, remote/radio controlled units, making it completely mobile, portable and able to move on its own.

The TS initiative counters drastic measures of an assailant targeting civilians using public transportation systems. Material discrimination methods are infiltrated within transport vehicles, along with real-time surveillance.

### BRIEF DESCRIPTION OF THE SEVERAL VIEWS OF THE DRAWING

The following drawings are intended to provide examples of how th bomb and firearm defense system may look. It is not intended to inhibit the invention.

FIG. 1. Samson and Gideon

FIG. 2. Samson and Gideon Transformation

FIG. 3. Samson and Gideon in its pre-Inspection Mode

FIG. 4. Samson and Gideon in Inspection Mode

FIG. 5. CAT-XRF Integration

FIG. 6. Handheld Device

FIG. 7. Jericho

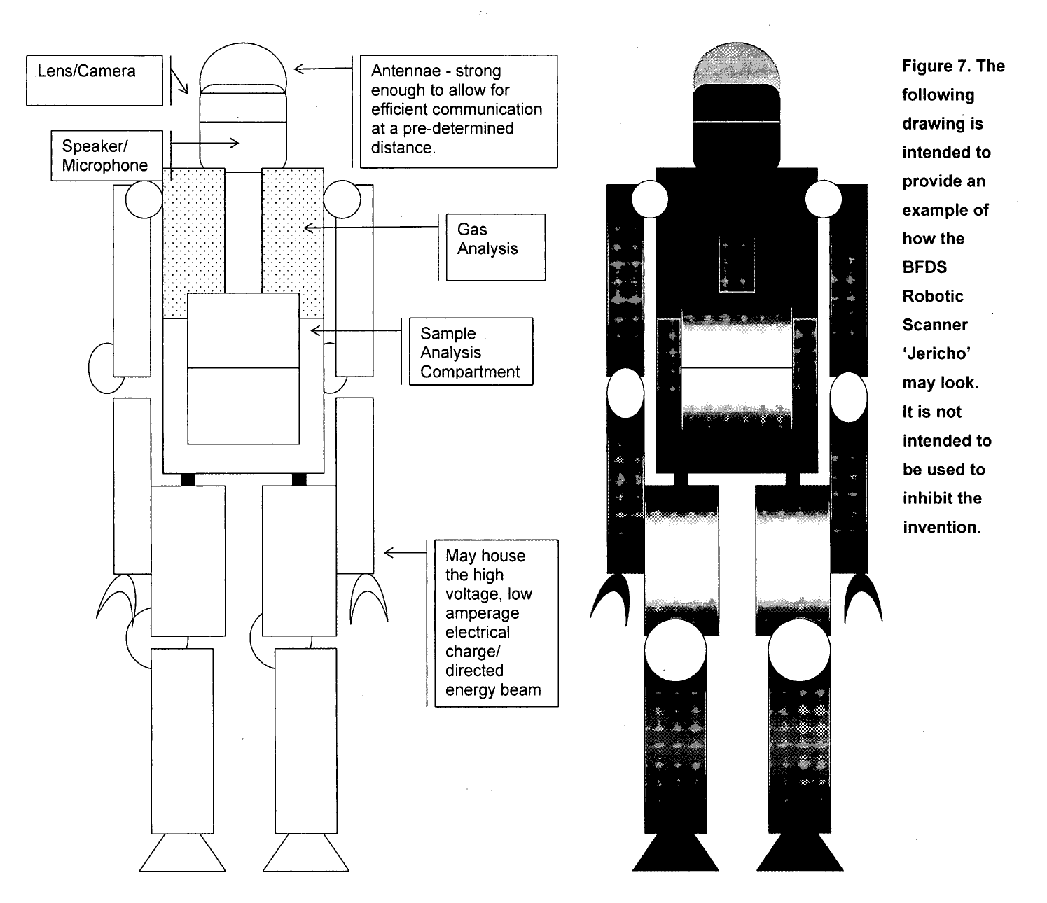

FIG. 8. BFDS Spider Cam

FIG. 9. BFDS Surveillance Station

FIG. 10. Public Transportation Floor Plan

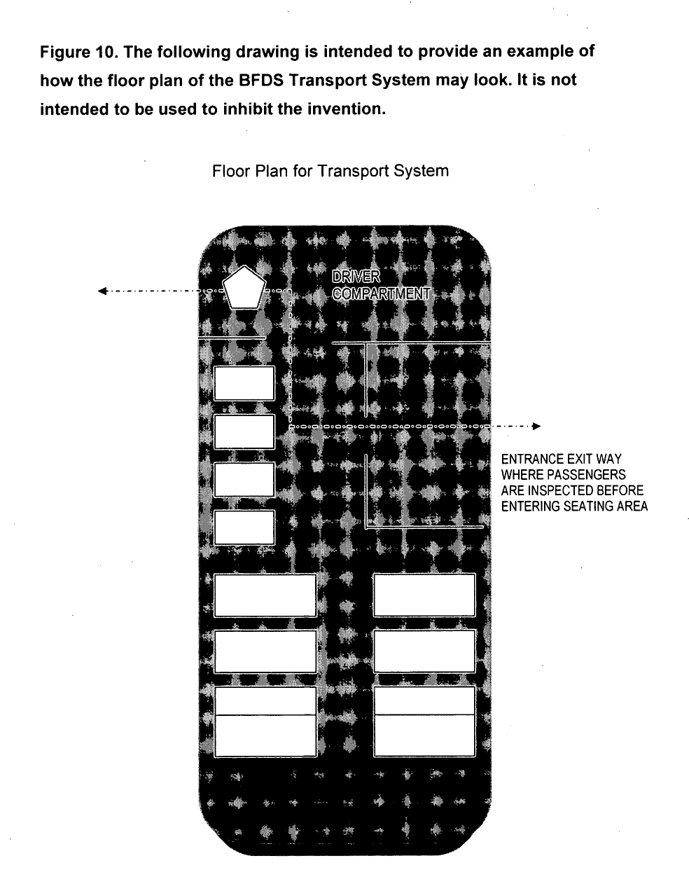

### DETAILED DESCRIPTION OF THE INVENTION

Robotic Scanners

Name Identification: Samson, Gideon

CAT and XRF Integration

Computer Axial Tomography enables electromagnetic energy to revolve around the body, where a 3-D computer model of what's been scanned is formulized. It was designed for the medical field and records images in X-Ray slices—combining those slices to form a detailed image. The advantage of Computer Axial Tomography is its spiral scanning, which allows for a more comprehensive result.

Additionally GlobalSpec, a resource for professionals in the engineering community, summed X-Ray Fluorescence Specrometry best as describing XRF as a spectroscopic technique in which X-Rays are used to excite a sample and generate secondary X-Rays. The sample is irradiated with a primary X-Ray beam and the X-Ray fluorescence is measured either simultaneously, or in sequential modes—and recorded with either an X-Ray detector (after wavelength dispersion) or with an energy-dispersive detector. The advantage of XRF is the ability to provide nondestructive rapid multi-element analysis and screen unknowns in a variety of sample matrices including, but not limited to: air filters, pastes, powders, solids, liquids, thin films and slurries.

BFDS integrates these techniques to create a single, comprehensive, contraband detection unit. With this improvement, firearms, blades, radioactive materials, shielding materials—and more—will be examined and identified. Further, equipping this methodology with robotic functions allow the apparatus to be utilized virtually anywhere: on highways, at ports, in buildings, on the street, in fields . . . the possibilities are endless.

Samson is the name identification for th robotic scanner designed for parcels/parcel sized investigation.

Gideon is the name identification for the robotic scanner (RS) designed for cargo/cargo sized investigation.

Samson and Gideon are remote/radio controlled by a handheld device. The processing unit is virtually shared between the two mechanisms. The movable structure, motors, sensors, balance system (gyroscopes), power supply, CAT-XRF operation, and data transmission are handled by the RS. Image and analysis display, robotic controls, communications, energy variant, and data record and download are managed by the handheld device.

The name identification (Samson, Gideon) correlates with the unique frequencies used for the communication between the RS and Handheld device. For instance, the hopping or rolling code between the transmitter and receiver are synchronized and identified by its corresponding names (Samson, Gideon). With regards to motion, the transmitter's controller chip (Handheld device) holds a 40-bit code with a function code that tells the receiver's controller chip (RS) what to do. These codes are sent through an established radio frequency. Both the RS and Handheld device contain radio transmitters and receivers to communicate efficiently. The actual component used is dependent upon the action taken. Another example includes the material inspection handled by the RS. As the examination is complete, the transmitter sends its analysis to the receiver located in the Handheld.

Accordingly, the two halves (RS and Handheld) of the overall ‘brain’ of the equipment work intimately with one another, creating one complete intellectual apparatus.

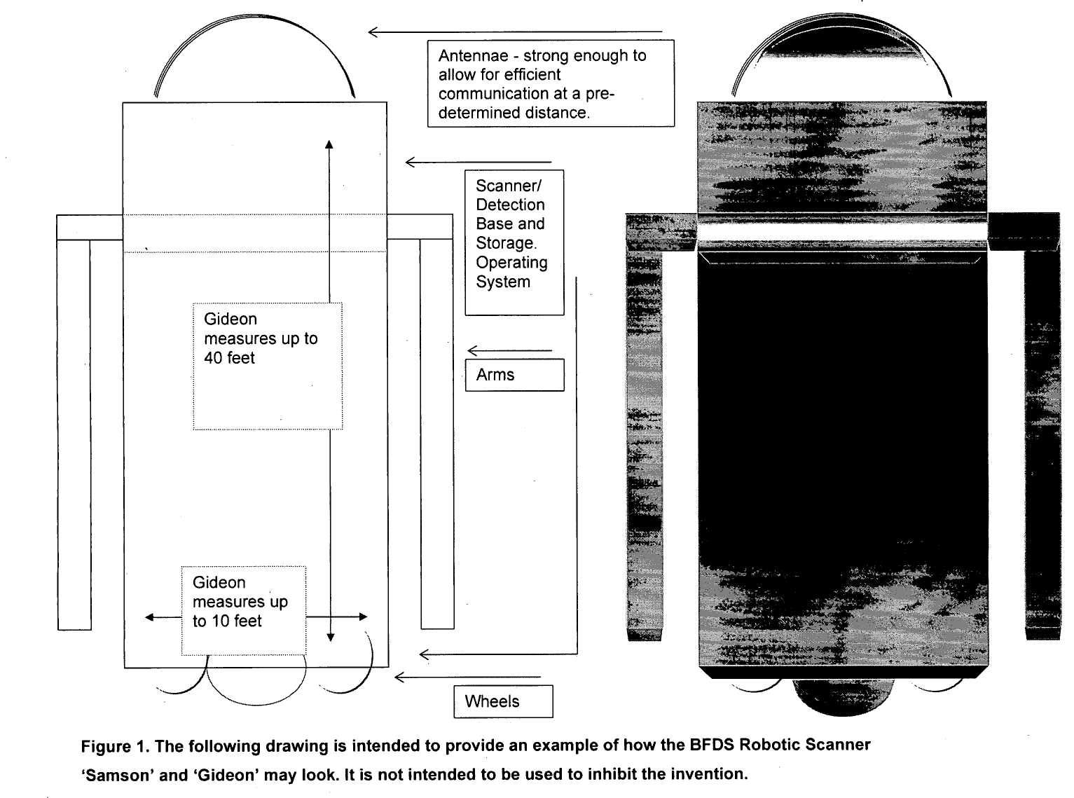

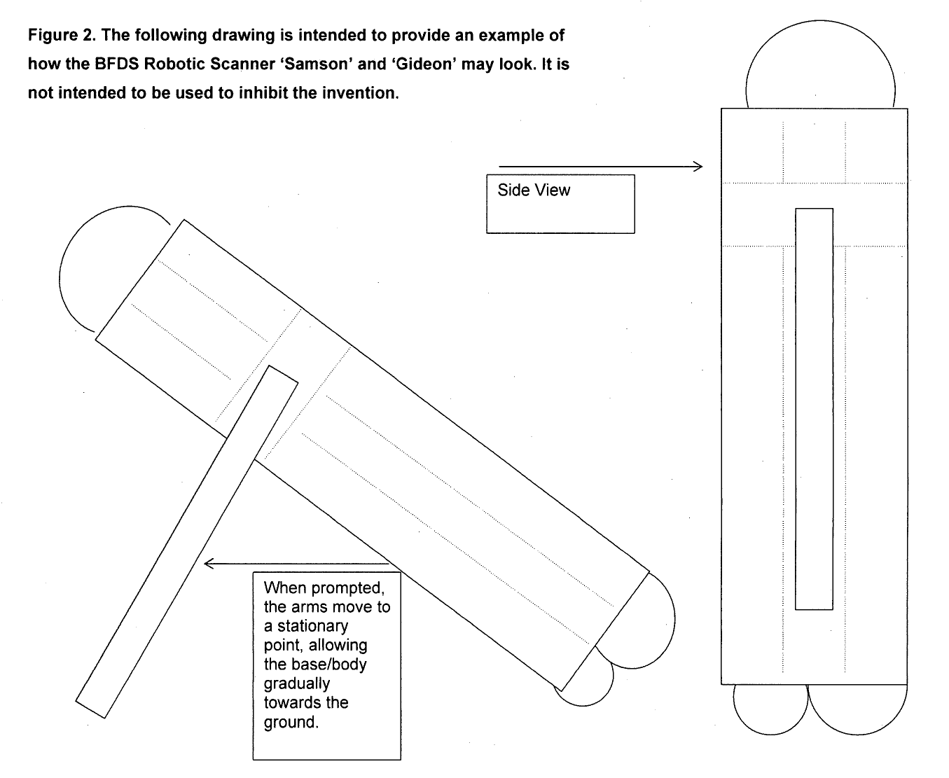

As the drawings (FIGS. 1 and 2) indicates, Samson and Gideon are capable of moving on its own and virtually transforms to a contraband inspection apparatus.

The machinery's arms acts as a leveler to lower the body of the robot to ground level.

Gideon (Cargo/Cargo sized) projects plates for loading and unloading materials. Its arms can serve as a palette lift to load materials onto its base (body) for inspection.

Samson (Parcel/Parcel sized) can also use its arms to lift material.

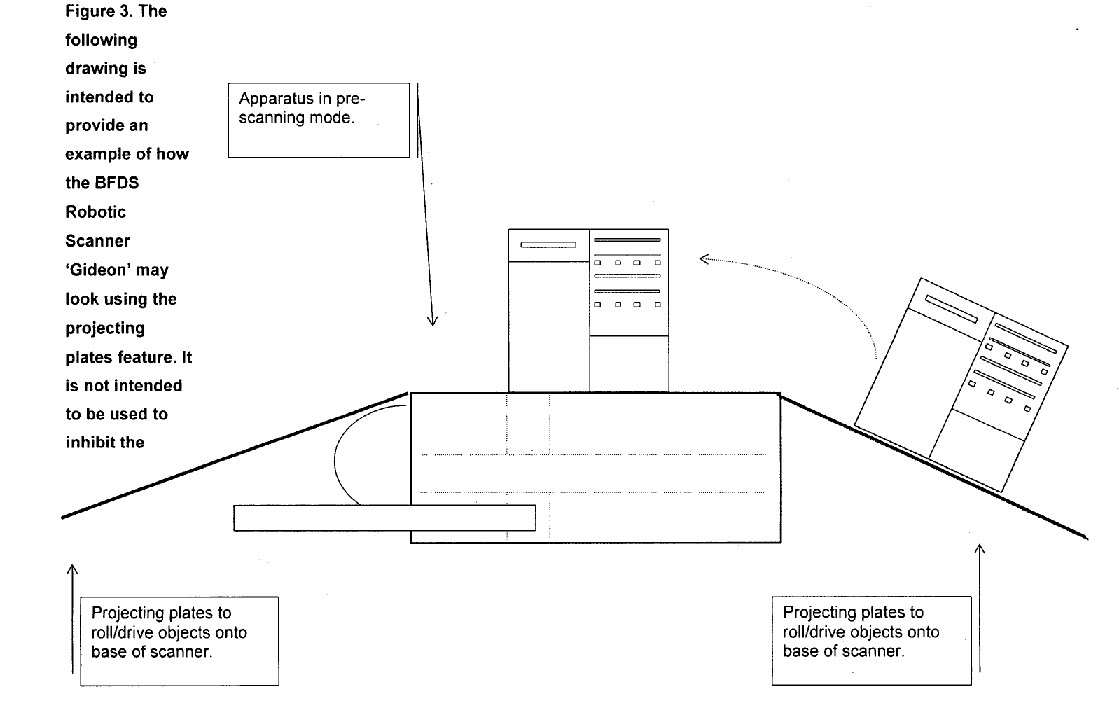

Once the robot is in its ground level position, items to be inspected are placed in the center (FIG. 3).

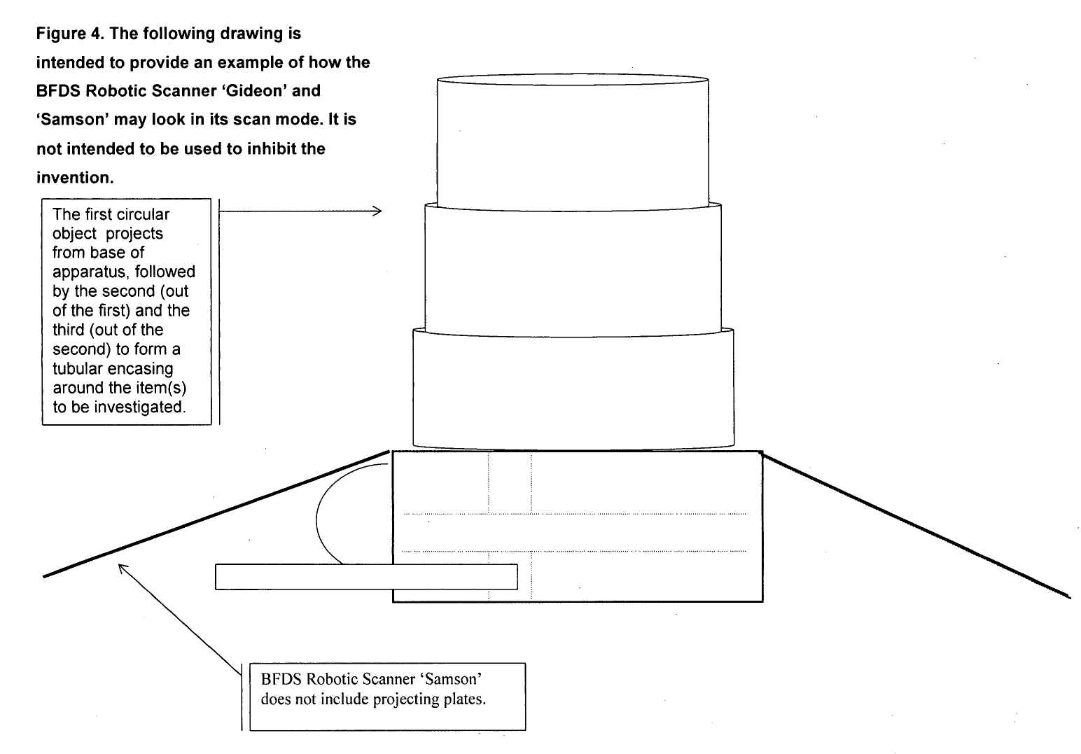

Circular objects project from the base of the apparatus (FIG. 4) encircling the items. These circular/cylinder objects not only project from the base of the machinery but also rotate 360 degrees around the items. The CAT-XRF system is located within these circular objects and as the cylinders rotate, items are scanned and examined slice by slice. The sliced images are pieced together and the overall image is sent to the handheld device for review.

Further, the X-Ray fluorescence is measured and the mass identified is also transmitted to the handheld device.

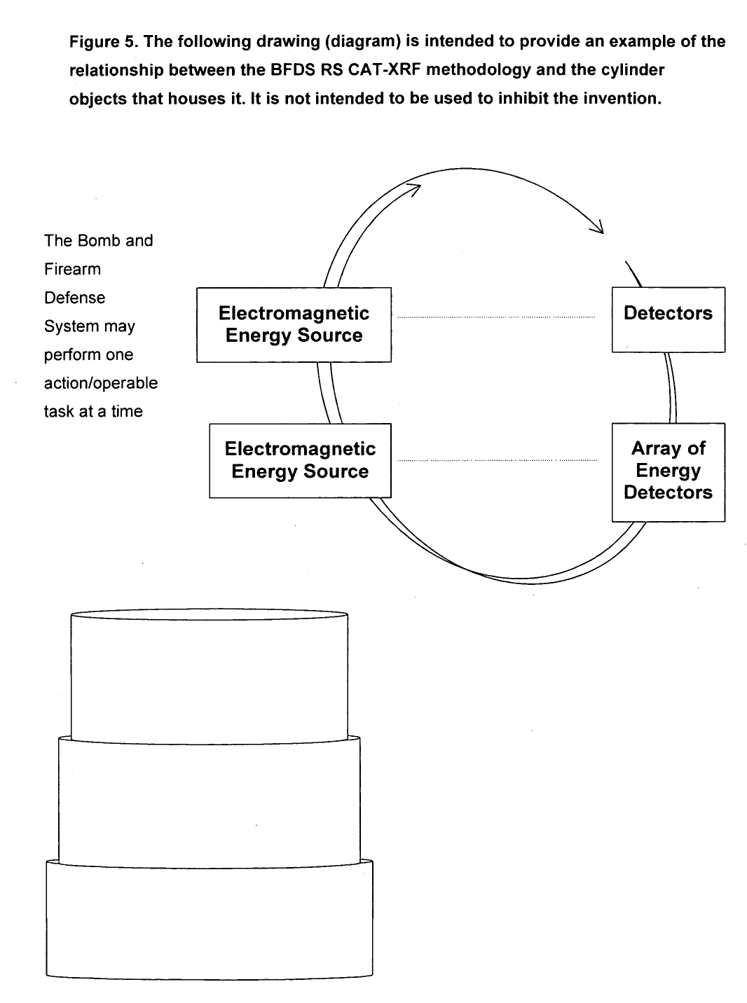

The CAT-XRF may be positioned side by side (FIG. 5) with multiple CAT-XRF systems—one for each rotating cylinder. The Bomb and Firearm Defense System may perform one action/operable task at a time (CAT first, then XRF or XRF first, then CAT, and so on).

Additionally, Samson and Gideon (including their corresponding handhelds) are installed with an established frequency tracking device to locate each component

Please refer to FIG. 5 for an exampled drawing of the handheld device.

Robotic Scanner

Name Identification: Jericho

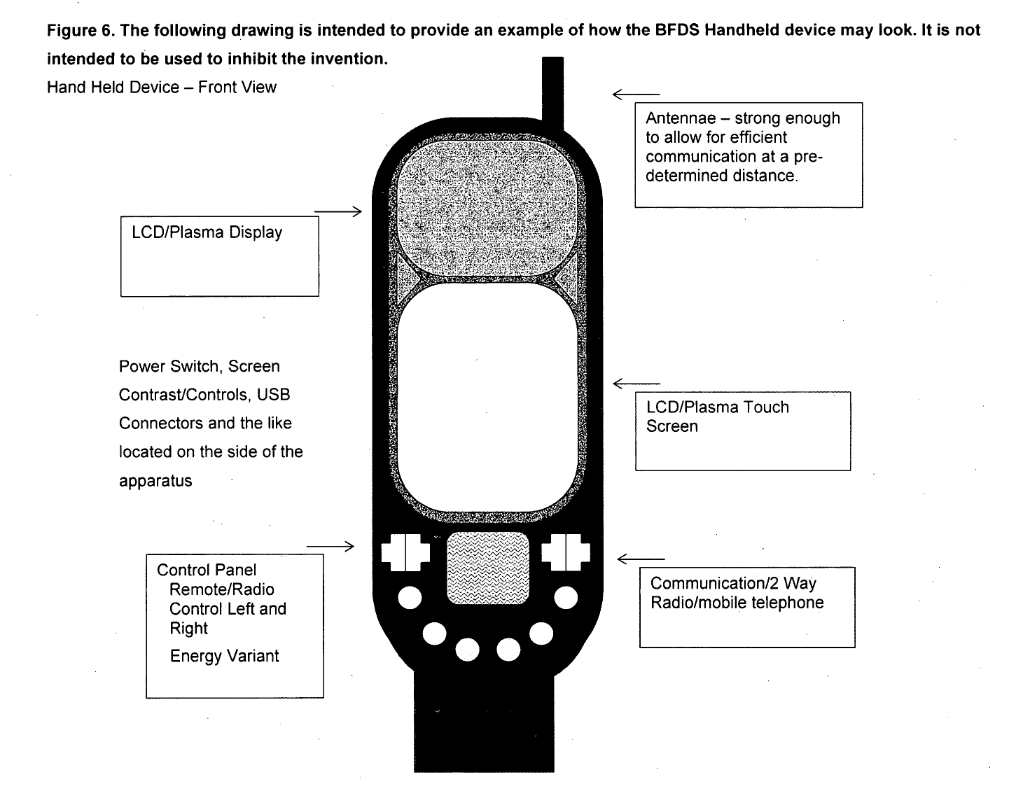

As the drawing (FIG. 6) indicates, Jericho is quite different from the previous robotic scanners. Its locomotion is in the form of legs. Because bipedal locomotion can be unstable, Jericho may initially glide on its legs using wheels, or similar thereof—while developing an efficient method of balance and adaptability (gyroscopes, joints, hydraulic/pneumatic pistons).

Jericho is virtually an autonomous robot, or partially controlled, able to act and respond on its own. Stereo vision (installation of 2 cameras) allows for its depth perception and image-recognition software (established prior arts) gives it the ability to locate and classify objects.

Jericho is intended to be used in hazardous or potentially hazardous areas, including: analyzing suspicious packages, detecting biological and chemical warfare agents in specified locations, security checkpoints, and suicide bombing proximities and so on.

Accordingly, Jericho is able to bend and use its arms to pick up materials to be examined.

The examination chamber is located within its belly/mid section. As Jericho picks up an item, sensors are used to open the doors of its mid section where the item is placed and (doors dosed) analyzed.

Virtually any spectrometry/scanning method can be adapted and infiltrated in the machinery.

Additionally, microphones/earphones are used to give it communication ability. Smell sensors and gas chromatography work together to pick up elements and analyze them.

All actions are monitored by its corresponding handheld device. As the machinery performs a certain function, data is transmitted to the handheld unit and recorded. A third camera is installed where real time images are transmitted and displayed (on the handheld). Handheld operators may also send certain functional instructions to Jericho, including (for example) words to speak at a security checkpoint.

With Jericho, the handheld works closely with the RS; however it is more of a monitoring/accountability device rather than the second half of its ‘brain’—as with Samson and Gideon.

Jericho also has high voltage, low amperage electrical charge capability, causing immobilization. This element of stun technology (established prior art) is particularly useful in hostile, populated areas, or security checkpoints. Jericho may also be adapted to utilize directed-energy beam weaponry (established prior art).

Additionally, Jericho (including their corresponding handhelds) is installed with an established frequency tracking device to locate each component.

Transport Systems

Traditional glass windows are replaced with a polycarbonate fire resistant substance. The driver's compartment is isolated with two entrance and exit ways.

All passengers go through an enclosed compartment layered with a polycarbonate, fire resistant substance with material discrimination (established prior arts such as x-ray scans, biometrics, and so on) capabilities. Individuals and/or belongings are scanned and analyzed and are not allowed to go into the seating area until cleared.

Another option is to enhance prior arts to perform inspections with little supervision. For instance, coding may involve pre-programmed images or colors of suspicious matter to be used as reference points.

As an individual/item is scanned, if the system detects a corresponding image, it triggers a notification signal to the driver or governing official who can respond accordingly. If no corresponding image is found, the entrance way opens to allow the passenger into the seating area.

The polycarbonate resin lessens the blow if an attacker chooses to detonate a bomb or begin a shooting spree.

Further, BFDS allows for all data (findings and actions) to be recorded and transmitted to a remote location. Transport systems are further enhanced with the option of real time monitoring using specialized ‘spider cams’ concealed behind one way vision screens.

Spider Camera

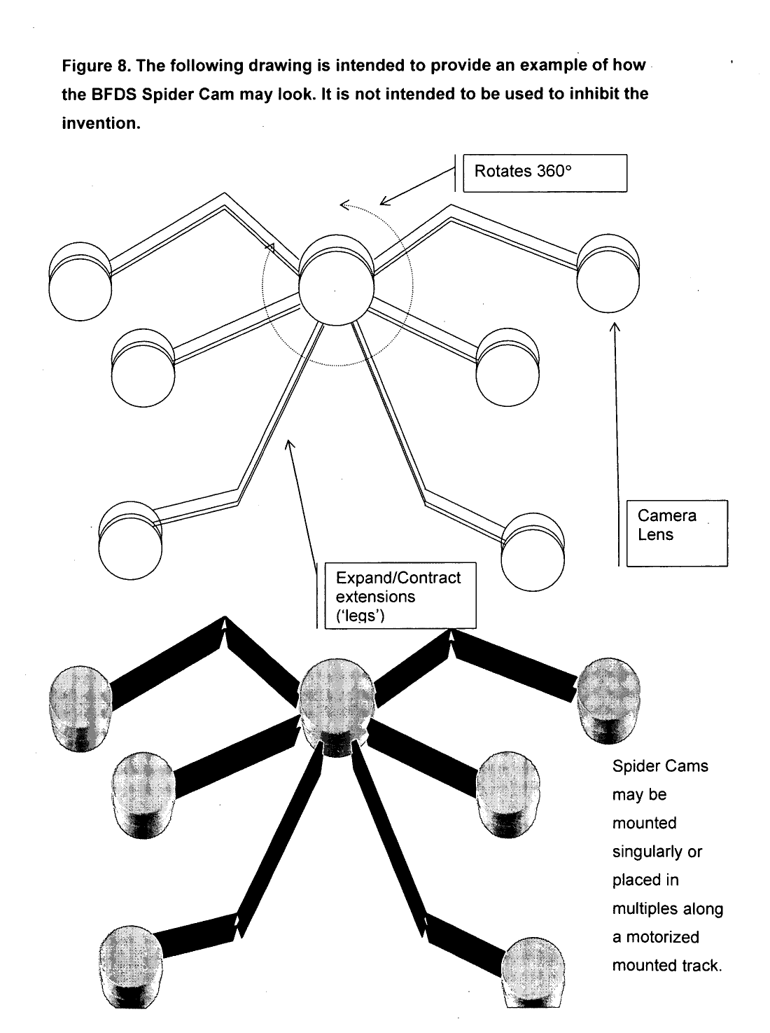

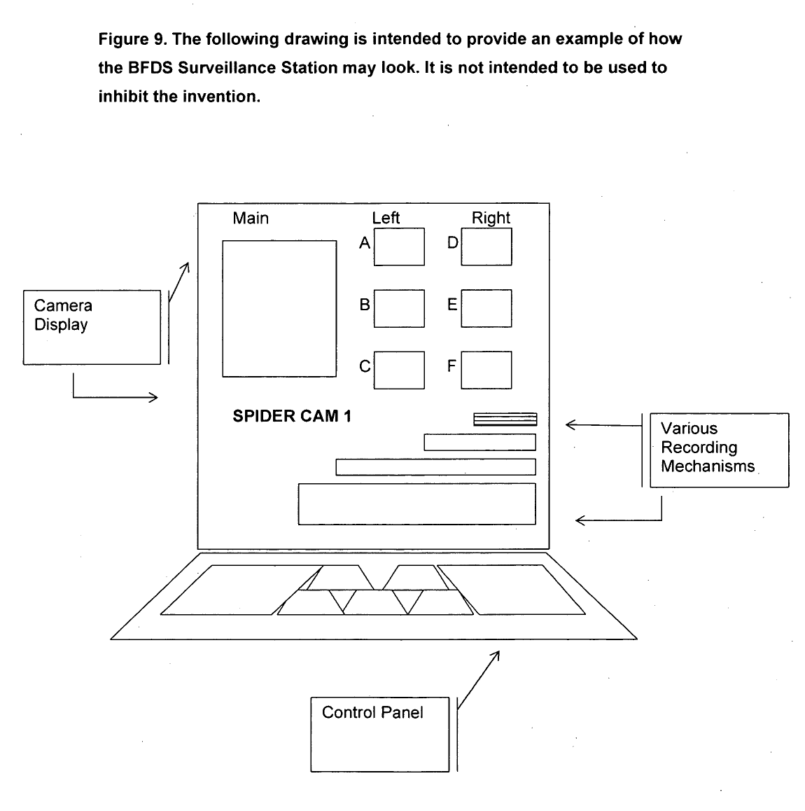

As the drawing (FIG. 8] indicates, this six legged machinery is equipped with cameras that gradually rotate 360 degrees. The motorized legs can extend/expand or curtail/contract. The controller uses a surveillance station similar to FIG. 9, where data received from the Spider Cams are stored. Enhanced options for this transport system include the overall automatic operation of the spider cams, data transmission and storage initiated at the remote location.

1. What is claimed as the invention is the creation of a portable, brained (computer), body motioned machinery embedded with the following elements, or combination thereof:
shape/multifunctional transformation;
spectrometry;
chromatography;
energy-induced scan;
data transmission;
high voltage, low amperage electrical charge;
directed energy beam.

2. What is claimed as the invention is a system or method of integrating the following components within a single, detection unit:
sliced, rotational energy-induced inspection with;
the measurement of masses and relative concentrations of atoms and molecules.

3. What is claimed as the invention is a system or method of integrating the following components within transportation vehicles:
surveillance;
material discrimination;
data transmission;
polycarbonate, fire resistant compound.

4. What is claimed as the invention is the creation of cameras (Spider Cams), comprised of the following:
multiple, attached lenses;
rotational mount;
expanding/contracting extensions (‘legs’);
extending/curtailing extensions (‘legs’);
manual or automatic modes of operation.
